(19) United States
(12) Patent Application Publication
(10) Pub. No.: US 2014/0201065 A1
(43) Pub. Date: Jul. 17, 2014

(54) SYSTEM FOR AND METHOD OF MOBILE FLEET DATA CAPTURE WITH REAL-TIME AUTHORIZATION DATA

(71) Applicant: MASTERCARD INTERNATIONAL INCORPORATED, Purchase, NY (US)

(72) Inventors: Jeffrey A. COX, O Fallon, MO (US); Aviva K. KLEIN, Toronto (CA); Kelly E. REID, Troy, MO (US)

(73) Assignee: MasterCard International Incorporated, Purchase, NY (US)

(21) Appl. No.: 13/739,204

(22) Filed: Jan. 11, 2013

(51) Int. Cl. G06Q 40/00

(52) U.S. Cl. CPC G06Q 40/00
USPC 705/39

(57) ABSTRACT

A method for creating a transaction record includes: receiving a request including an identifier from a mobile device; identifying a consumer data entry related to a consumer and including the identifier; identifying transaction data related to a transaction involving the consumer; transmitting the data to the mobile device; receiving additional details from the mobile device; and creating a transaction record, the transaction record associated with the consumer including at least the transaction data and the additional details. A method for submitting transaction details includes: identifying an identifier associated with a user of a mobile device; transmitting a transaction request to a server, the transaction request including the identifier; receiving transaction data from the server for a transaction involving the user; displaying the received transaction data to the user; receiving additional details; and transmitting the additional details to the server for the creation of a transaction record for the transaction.

### FIELD

The present disclosure relates to the submission of transaction details and creation of transaction records, specifically the creation of transaction records for fleet transactions using a mobile communication device utilizing real-time authorization data.

### BACKGROUND

Fleet cards have a long history of use by corporations and other entities for maintaining better record keeping and control of their drivers' purchase of fuel and maintenance services. Fleet cards may have an advantage over credit cards and traditional cash purchases as they can provide an entity with more in-depth and comprehensive reporting regarding transactions, and they can also reduce instances of fraud by the limits of their use.

However, although fleet cards can provide entities with transaction reports that provide more detail than credit cards, in many instances entities must rely on their drivers to provide additional information to supplement the transaction record. For example, many entities require drivers to provide detailed information regarding services purchased, or additional transaction details when fuel is purchased, such as the mileage of the vehicle, the price of the fuel, and the type of fuel. Using a traditional fleet card, an invoice or other number may be entered for the purchase, and the driver may fill out a separate report regarding the additional information, which the entity may match to the transaction via the invoice or other identifying number. Such a process may be cumbersome, as the driver spends less time on the road and more time filling out reports, or details may be lost or reporting incorrectly if the driver does not fill out a report immediately.

Thus, there is a need for a technical solution for capturing fleet data in real-time that may provide entities with additional information regarding fleet transactions while requiring less time and resources of both the driver and the entity.

### SUMMARY

The present disclosure provides a description of a systems and methods for the creation of a transaction record and the submitting of transaction details.

A method for creating a transaction record includes: receiving, by a receiving device, a transaction request from a mobile communication device, wherein the transaction request includes at least a consumer identifier; identifying, in a consumer database, a consumer data entry storing data related to a consumer, wherein the identified consumer data entry includes the consumer identifier; identifying, in a transaction database, transaction data related to a financial transaction involving the consumer related to the identified consumer data entry; transmitting, by a transmitting device, the identified transaction data to the mobile communication device; receiving, by the receiving device, additional transaction details from the mobile communication device; and creating, by a processing device, a transaction record for the financial transaction, wherein the transaction record includes at least the transaction data and the additional transaction details and is associated with the consumer.

A method for submitting transaction details includes: identifying, by a processing device, a consumer identifier associated with a user of a mobile communication device; transmitting, by a transmitting device, a transaction request to a server, wherein the transaction request includes at least the consumer identifier; receiving, by a receiving device, transaction data from the server for a financial transaction involving the user; displaying, by a display device, the received transaction data to the user; receiving, by an input device, additional transaction details associated with the financial transaction; and transmitting, by the transmitting device, the additional transaction details to the server for the creation of a transaction record for the financial transaction.

A system for creating a transaction record includes a receiving device, a processing device, and a transmitting device. The receiving device is configured to receive a transaction request from a mobile communication device, wherein the transaction request includes at least a consumer identifier. The processing device is configured to identify, in a consumer database, a consumer data entry storing data related to a consumer, wherein the identified consumer data entry includes the consumer identifier, and identify, in a transaction database, transaction data related to a financial transaction involving the consumer related to the identified consumer data entry. The transmitting device is configured to transmit the identified transaction data to the mobile communication device. The receiving device is further configured to receive additional transaction details from the mobile communication device. The processing device is further configured to create a transaction record for the financial transaction, wherein the transaction record includes at least the transaction data and the additional transaction details and is associated with the consumer.

A system for submitting transaction details includes a processing device, a transmitting device, a receiving device, a display device, and an input device. The processing device is configured to identify a consumer identifier associated with a user of a mobile communication device. The transmitting device is configured to transmit a transaction request to a server, wherein the transaction request includes at least the consumer identifier. The receiving device is configured to receive transaction data from the server for a financial transaction involving the user; displaying, by a display device, the received transaction data to the user. The input device is configured to receive additional transaction details associated with the financial transaction. The transmitting device is further configured to transmit the additional transaction details to the server for the creation of a transaction record for the financial transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for creating and distribution transaction records and details in accordance with exemplary embodiments.

FIG. 2 is a diagram illustrating a processing server for use in the system of FIG. 1 in accordance with exemplary embodiments.

FIG. 3 is a diagram illustrating a mobile device for use in the system of FIG. 1 in accordance with exemplary embodiments.

FIG. 4 is a flow diagram illustrating a method for creating a transaction record in accordance with exemplary embodiments.

FIG. 5 is a flow diagram illustrating a method for submitting transaction details in accordance with exemplary embodiments.

FIGS. 6A-6E are diagrams illustrating a graphical user interface for viewing transaction records and submitting transaction details in accordance with exemplary embodiments.

FIG. 7 is a flow chart illustrating an exemplary method for creating a transaction record in accordance with exemplary embodiments.

FIG. 8 is a flow chart illustrating an exemplary method for submitting transaction details in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Fleet Card—A fleet card (e.g., fuel card) is a payment card or transaction card that may be used for the purchase of fuel and vehicle expenses, such as vehicle parts, maintenance, and services, as well as, in some instances, additional expenses incurred by the vehicle's driver. A fleet card may be issued by an issuing bank or financial institution to an entity, such as a person or a company. In some instances, a fleet card may be issued to a company and associated with a particular driver (e.g., an employee of the company) and/or a particular vehicle. In one instance, a fleet card may be a credit card or controlled payment number that has been modified to perform as a fleet card. Additionally, fleet card transactions may be input into accounting software. Methods for processing transactions and regarding controlled payment and accounting functions using fleet cards will be apparent to persons having skill in the relevant art, and may be found in U.S. Pat. No. 6,315,193; U.S. Pat. No. 6,793,131; U.S. application Ser. No. 10/914,766, filed on Aug. 9, 2004; U.S. application Ser. No. 11/560,212, filed on Nov. 15, 2006; U.S. application Ser. No. 12/219,952, filed on Jul. 30, 2008; and International Application No. PCT/US2009/005029, filed on Sep. 19, 2009, U.S. Published Patent Application No. 2009/0037333, filed on Jul. 30, 2008, which are all herein incorporated by reference in their entirety. It will be further apparent to persons having skill in the relevant art that fleet cards may be used for non-fuel purchase as set forth by the user and/or the entity to which the card is issued. For example, a fleet card may be issued to a company, which may provide that a driver may use the fleet card for both fuel purchase as well as non-fuel purchases while at a rest stop, such as for oil, washer fluid, snacks, drinks, etc.

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, American Express®, and Discover®, for example.

### System for Distributing Offers and Profiles Based on Redemption History

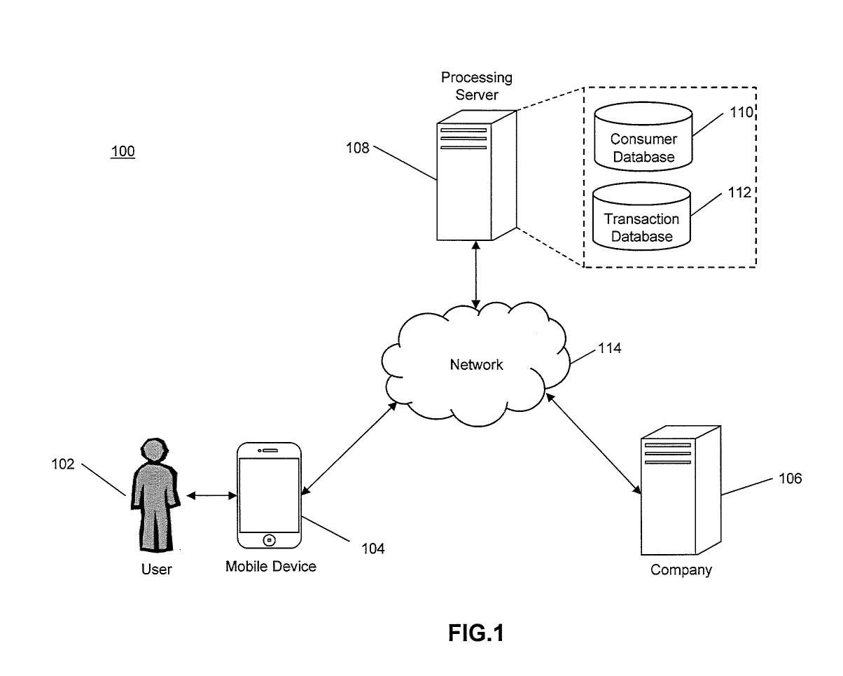

FIG. 1 is a high level architecture illustrating a system 100 for submitting and receiving transaction details and creating a transaction record for a fleet transaction.

The system 100 may include a user 102, a mobile device 104, a company 106, and a processing server 108. Each of the components may be configured to communicate (e.g., directly, or via a communication device such as a cellular phone, smart phone, computer, etc.) via a network 114. The network 114 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. In some embodiments, the network 114 may be a payment network and may include the processing server 108. Other suitable network types and configurations will be apparent to persons having skill in the relevant art.

The user 102 may be a driver or employee of the company 106. The company 106 may provide the user 102 with a fleet card for funding financial transactions involving a vehicle owned and/or operated by the company 106. The user 102 may furthermore possess the mobile device 104. The mobile device 104 may be any type of mobile communication device suitable for performing the functions as disclosed herein, such as a cellular phone, smart phone, tablet computer, notebook computer, netbook, laptop computer, etc. In some embodiments, the mobile device 104 may be issued to the user 102 by the company 106.

The user 102 may engage in a financial transaction at a merchant and use the fleet card for funding the transaction. In an exemplary embodiment, the financial transaction may be for the purchase of fuel or other related vehicle expenses. In some embodiments, the financial transaction may be for any product or service as specified by the company 106. In a further embodiment, the products or services may include non-fuel or non-vehicle expenses, such as refreshments, maps, etc. The financial transaction may be processed via a payment network. The processing server 108 may receive transaction information corresponding to the financial transaction, discussed in more detail below, which the processing server 108 may store in a transaction database 112. In some embodiments, the processing server 108 may be a part of the payment network. In a further embodiment, the processing server 108 may be configured to process financial transactions and may store transaction details for each financial transaction in the transaction database 112 as part of the transaction processing.

The processing server 108 may also include a consumer database 110, which may store data related to a plurality of consumers, such as the user 102 and/or the mobile device 104. The processing server 108 may, as discussed in more detail below, identify the user 102 and the mobile device 104 associated with the user 102 and may transmit transaction details for the financial transaction to the mobile device 104. The user 102 may view the transaction details using the mobile device 104 and may, as discussed in more detail below, input additional information into the mobile device 104. The mobile device 104 may then transmit the additional information to the processing server 108. The processing server 108 may update the data related to the financial transaction in the transaction database 112 with the additional information and may create a transaction record based on the updated transaction.

The processing server 108 may be configured to transmit the created transaction record to the company 106. The company 106 may then receive the transaction record, which may include the transaction information as well as additional information provided by the user 102. In such an instance, the company 106 may be able to receive a complete transaction record from the user 102 quickly after the transaction has been completed, without having to receive the transaction and additional information separately and match the components of the record together. Furthermore, as discussed in more detail below, the mobile device 104 may enable the user 102 to submit the additional information more efficiently than in existing methods.

### Processing Server

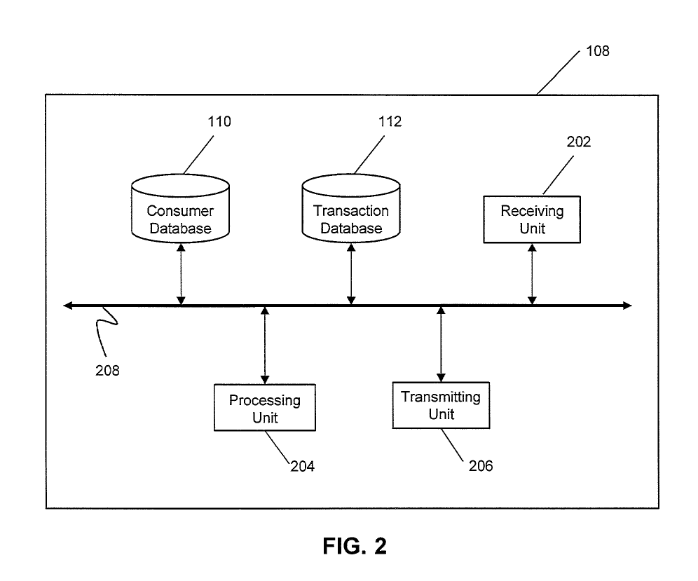

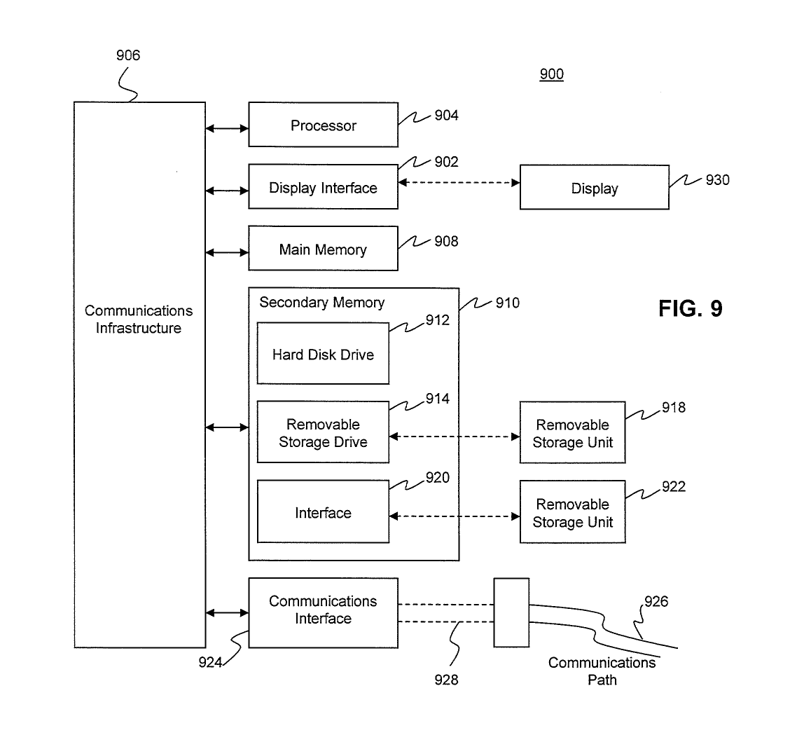

FIG. 2 illustrates an embodiment of the processing server 108 for use in the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 900 illustrated in FIG. 9 and discussed in more detail below may be a suitable configuration of the processing server 108.

The processing server 108 may include the consumer database 110, the transaction database 112, a receiving unit 202, a processing unit 204, and a transmitting unit 206. Each of the components may be configured to communicate via a bus 208. Suitable types and configurations for the bus 208 will be apparent to persons having skill in the relevant art. Additional components or configurations of the processing server 108 will also be apparent to persons having skill in the relevant art.

The consumer database 110 may be configured to store a plurality of consumer data entries, wherein each consumer data entry is related to a consumer (e.g., the user 102) and includes at least a consumer identifier. The consumer identifier may be any unique value suitable for identifying the user 102, such as a username, an e-mail address, a phone number, a serial number, an identification number, a financial account number, etc. In some embodiments, the consumer identifier may be associated with the mobile device 104. For example, the consumer identifier may be a media access control (MAC) address for the mobile device 104. In other embodiments, the consumer identifier may not be associated with the mobile device 104, but the mobile device 104 may be associated with the consumer data entry related to the user 102. In such an embodiment, the mobile device 104 may be associated with the consumer data entry using an identifier, such as the MAC address. In one embodiment, the consumer identifier may be a payment account number corresponding to a fleet card issued to the company 106.

The transaction database 112 may be configured to store transaction data related to a plurality of financial transactions. Transaction data stored in the transaction database 112 will be apparent to persons having skill in the art and may include transaction date, transaction time, transaction amount, a consumer identifier (e.g., an identifier associated with the user 102 for transactions involving the user 102), funding information, product information, merchant information, etc. In some embodiments, the processing server 108 may store specific transaction data indicated by the company 106 for financial transactions involving the company 106 (e.g., based on the funding information corresponding to a fleet card issued to the company 106).

Data stored in the consumer database 110 and the transaction database 112 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 114).

The receiving unit 202 may be configured to receive information and data (e.g., via the network 114). The receiving unit 202 may receive financial transaction data related to financial transactions, such as from a payment network. The processing unit 204 may be configured to store the received financial transaction data in the transaction database 112. The processing unit 204 may be further configured to identify, in the consumer database 110, a consumer data entry corresponding to the received financial transaction, such as based on an included consumer identifier. The processing unit 204 may cause the transmitting unit 206 to transmit the received financial transaction data to the mobile device 104 associated with the user 102 related to the identified consumer data entry.

The receiving unit 202 may be further configured to receive additional transaction information (e.g., transmitted to the processing server 108 by the mobile device 104). In some embodiments, the processing unit 204 may update the transaction data in the transaction database 112 for the financial transaction with the received additional transaction information. The processing unit 204 may be configured to create a transaction record for the financial transaction based on the financial transaction data and the additional transaction information. In one embodiment, the processing unit 204 may include specific information in the created transaction record as requested by the company 106. The transmitting unit 206 may then transmit the created transaction record to the company 106.

### Mobile Device

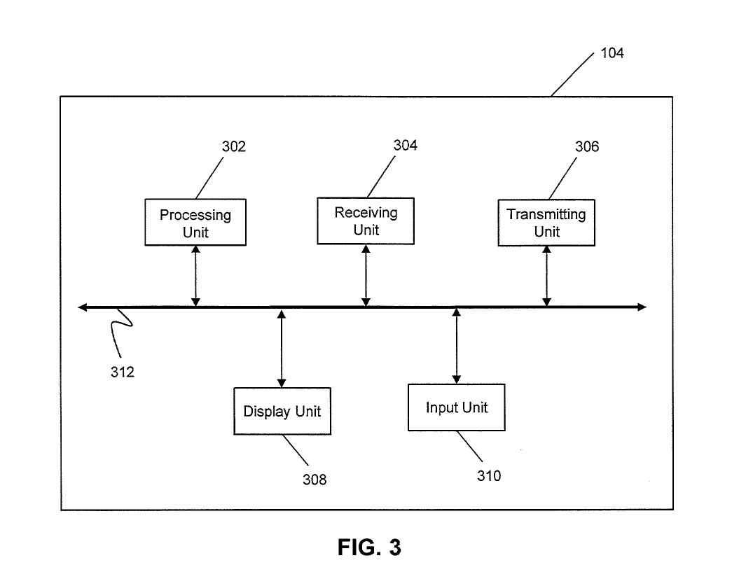

FIG. 3 illustrates an embodiment of the mobile device 104 for use in the system 100. It will be apparent to persons having skill in the relevant art that the embodiment of the mobile device 104 illustrated in FIG. 3 is provided as illustration only and may not be exhaustive to all possible configurations of the mobile device 104 suitable for performing the functions as discussed herein. For example, the computer system 900 illustrated in FIG. 9 and discussed in more detail below may be a suitable configuration of the mobile device 104.

The mobile device 104 may include a processing unit 302, a receiving unit 304, a transmitting unit 306, a display unit 308, and an input unit 310. Each of the components may be configured to communicate via a bus 312. Suitable types and configurations of the bus 312 will be apparent to persons having skill in the relevant art.

The processing unit 302 may be configured to identify a consumer identifier associated with a user (e.g., the user 102) of the mobile device 104. In one embodiment, identifying a consumer identifier may include requesting, from the user, the consumer identifier, which may be received via the input unit 310. The transmitting unit 306 may be configured to transmit a transaction request including the consumer identifier to the processing server 108. The receiving unit 304 may then receive transaction data for a financial transaction involving the user 102 from the processing server 108. In an alternative embodiment, the receiving unit 304 may receive the transaction data for the financial transaction without the prior transmission of a transaction request to the processing server 108. For example, the processing server 108 may be configured to transmit transaction data to the mobile device 104 upon its receipt (e.g., directly after the financial transaction is processed). In such an embodiment, the mobile device 104 may be configured (e.g., via the display unit 308) to notify the user 102 of the receipt of new transaction data.

The display unit 308 may be configured to display the received transaction data for the financial transaction. The display unit 308 may also display at least one input field to request or permit input of additional information from the user 102 (e.g., special notes, comments or other information as desired or required by the company), the input of such additional information being optional to the basic operation of the present method. In some embodiments, the transaction data may indicate the at least one input field to be displayed. In one embodiment, the display unit 308 may display a plurality of input fields and may indicate at least one of the input fields of the plurality of input fields as being required. The input unit 310 may then receive input of additional information by the user 102 corresponding to the at least one input field. The processing unit 302 may perform any necessary processing of the received input and then may cause the transmitting unit 306 to transmit the input additional information to the processing server 108 for use in the creation of the transaction record.

In some embodiments, the mobile device 104 may further include a storage unit, which may be configured to store code corresponding to an application program. In such an embodiment, the processing unit 302 may be configured to execute the application program, which may enable the mobile device 104 to perform the functions as disclosed herein. In a further embodiment, the application program may be a web browsing program, and the user 102 may navigate to a webpage (e.g., hosted by or on behalf of the processing server 108 and/or the company 106) for the input of additional transaction information. Configurations of application programs on the mobile device 104 and methods for the display of data and receipt of input on the mobile device 104 will be apparent to persons having skill in the relevant art.

### Process of Creating a Transaction Record

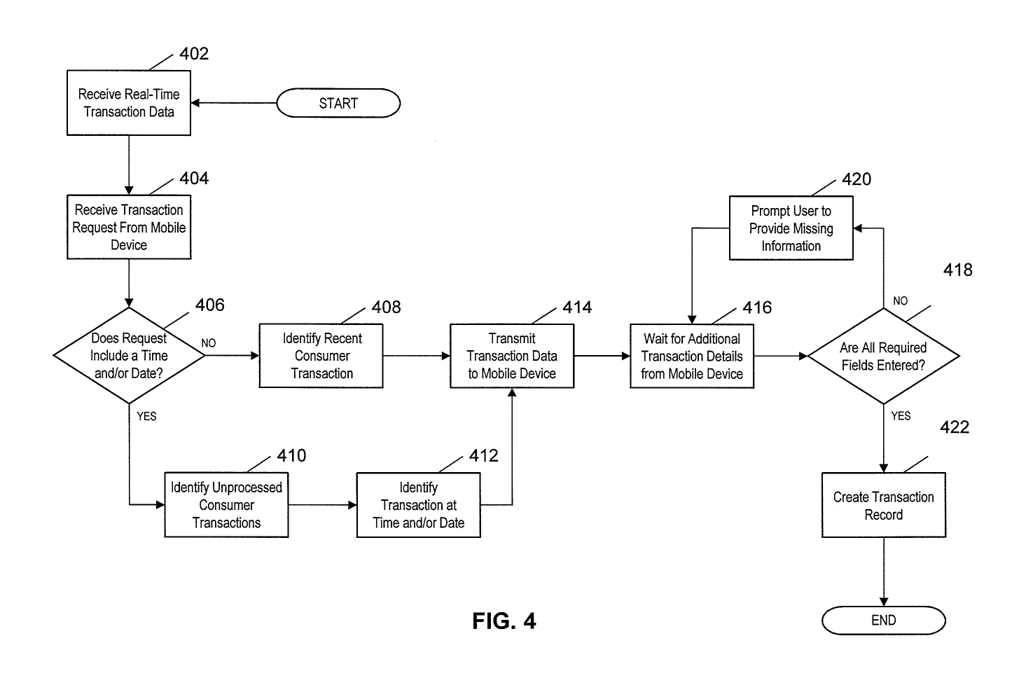

FIG. 4 illustrates a process for the creation of a transaction record by the processing server 108.

In step 402, the processing server 108 may receive (e.g., via the receiving unit 202) and store (e.g., in the transaction database 112) real-time transaction data. The real-time transaction data may be transaction data related to a financial transaction involving the user 102 and may include at least a consumer identifier. In step 404, the receiving unit 202 may receive a transaction request from the mobile device 104. The transaction request may include at least a consumer identification.

In step 406, the processing unit 204 may identify if the transaction request includes a time and/or date. If the transaction request does not include a time and/or date, then the processing unit 204 may identify, in step 408, the most recent unprocessed (e.g., where the user 102 has not provided required additional information) financial transaction involving the user 102 of the mobile device 104 based on the consumer identification included in the transaction request.

If the transaction request does include a time and/or date, then, in step 410, the processing unit 204 may identify, in the transaction database 112, financial transactions involving the user 102 of the mobile device 104 based on the consumer identification included in the transaction request that are unprocessed. Unprocessed financial transactions may be identified when the transaction data for the financial transaction does not include required additional information, such as information indicated by the company 106 as being required for financial transactions involving the company 106. In step 412, the processing unit 204 may identify, out of the identified unprocessed transactions, a specific transaction based on the time and/or date included in the transaction request.

In step 414, the transmitting unit 206 may transmit transaction data for the identified financial transaction to the mobile device 104. In some embodiments, the transmitting unit 206 may transmit only specific transaction data to the mobile device 104 as indicated by the company 106. In one embodiment, the transaction data may include an indication of required additional transaction information to be supplied by the user 102 of the mobile device 104.

In step 416, the processing server 108 may wait for and receive additional transaction details from the mobile device 104. Additional transaction details may include, for example, an approval code, a fuel quantity, a fuel unit price, a fuel type, a service type, an odometer reading, or an invoice number. In some embodiments, additional transaction details may include a transaction category (e.g., for non-fuel purchases) and a description (e.g., to describe the purchases made in the selected transaction category). In step 418, the processing unit 204 may determine if all required additional transaction information has been supplied. If the processing unit 204 determines that more information is required, then, in step 420, the transmitting unit 206 may transmit a notification to the mobile device 104 to prompt the user 102 to provide the missing additional information. If the processing unit 204 determines that all required information has been received, then, in step 422, the processing unit 204 may create a transaction record for the financial transaction based on the transaction data and the additional transaction information. In one embodiment, information to be included in the transaction record may be indicated by the company 106. In some embodiments, the process may further include transmitting, by the transmitting unit 206, the created transaction record to the company 106.

### Process of Submitting Transaction Information

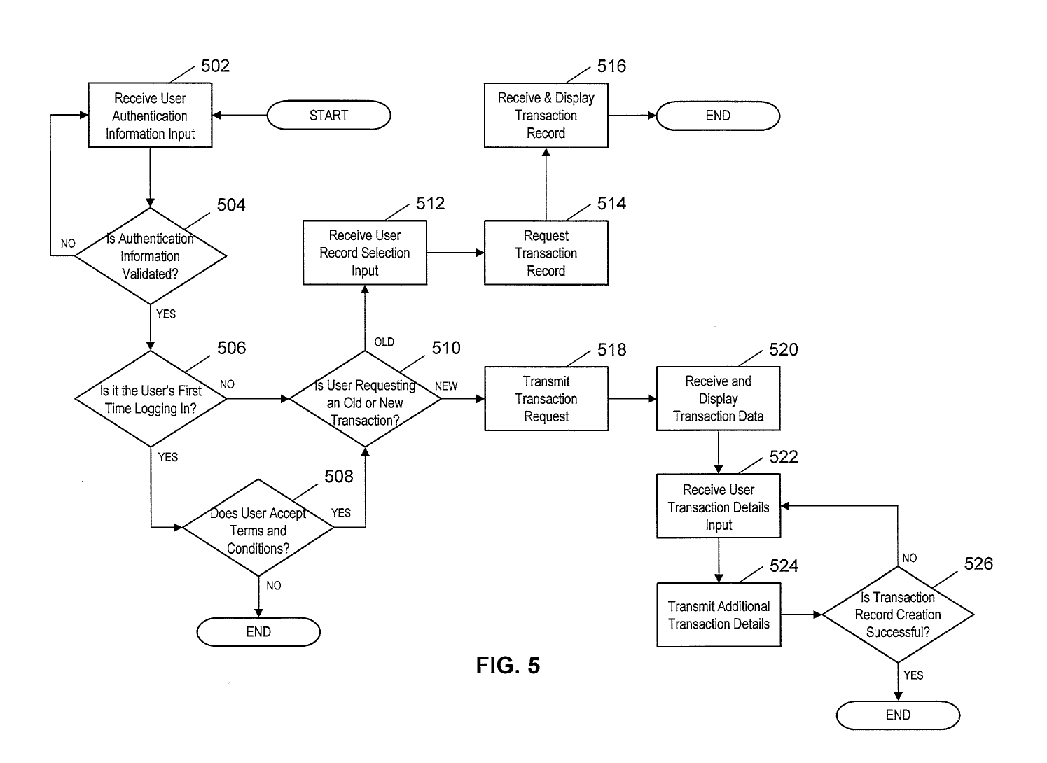

FIG. 5 process for the submitting of transaction information to the processing server 108 by the mobile device 104.

In step 502, the input unit 310 may receive authentication information input by the user 102 of the mobile device 104. The authentication information input by the user 102 may include any information suitable for authenticating the identity of the user 102 (e.g., or the vehicle operated by the user 102) and/or the fleet card used by the user 102 in a financial transaction. For example, the authentication information may include a consumer identifier (e.g., a username, password, e-mail address, phone number, etc.), a fleet card payment account number, a vehicle identification number (VIN), etc. In step 504, the processing unit 302 may attempt to validate the authentication information (e.g., by communicating with the processing server 102, identifying information included in a storage database, etc.) to verify the identity of the user.

In step 506, the processing unit 302 may identify if it is the user's 102 first time logging in. The processing unit 302 may identify if it is the user's 102 first time based on an indication in a storage database or received from the processing server 108 associated with the consumer identifier (e.g., or other provided authentication information) input by the user 102. If it is the user's 102 first time, then, in step 508, the processing unit 302 may cause the display unit 308 to display terms and conditions to the user 102 and prompt the user to accept the terms and conditions via the input unit 310. In one embodiment, the terms and conditions may be supplied to the mobile device 104 by the company 106 (e.g., via an application program running on the mobile device 104).

If the user 102 does not accept, via the input unit 310, the terms and conditions, then the process may end. If the user 102 does accept, then, in step 510, the display unit 308 may display a prompt to the user 102 to identify if the user 102 is requesting to view a previous financial transaction or to view and/or process a new (e.g., unprocessed) financial transaction.

If the user 102 indicates (e.g., via the input unit 310), that they are requesting a previous financial transaction, then, in step 512, the display unit 308 may prompt the user to select a previous transaction record via the input 310. In one embodiment, the display unit 308 may display a list of previous transaction records. In another embodiment, the display unit 308 may display input fields to receive information for identifying a previous transaction record, such as a transaction time and/or date or an identification number (e.g., an invoice number, approval number, etc.). In step 514, the transmitting unit 306 may transmit a request for a transaction record to the processing server 108, wherein the request includes at least one identifying piece of information for identifying the transaction record. In step 516, the receiving unit 304 may receive the requested transaction record and the display unit 308 may display the transaction record to the user 102.

If the user 102 indicates that they are requesting a new transaction, then, in step 518, the transmitting unit 306 may submit a transaction request, where the transaction request includes at least a consumer identifier. In one embodiment, the user 102 may additionally input, via the input unit 310, a transaction time and/or date for inclusion in the transaction request. In step 520, the receiving unit 304 may receive transaction data for a financial transaction and the display unit 308 may display the transaction data to the user 102. The display of the transaction data may include at least one input field for the input of required additional information.

In step 522, the input unit 310 may receive input from the user 102 of additional transaction details or information. In one embodiment, the additional transaction details may include an approval code, a fuel quantity, a fuel unit price, a fuel type, a service type, an odometer reading, and/or an invoice number. In some embodiments, additional transaction details may include a transaction category (e.g., for non-fuel purchases) and a description (e.g., to describe the purchases made in the selected transaction category). In step 524, the transmitting unit 306 may transmit the additional transaction details to the processing server 108. Then, in step 526, the processing unit 302 may identify if creation of the transaction record is successful. If creation of the record is not successful, then the process may return to step 522 to prompt the user to provide all necessary additional transaction details for the creation of the transaction record for the financial transaction.

### Graphical User Interface

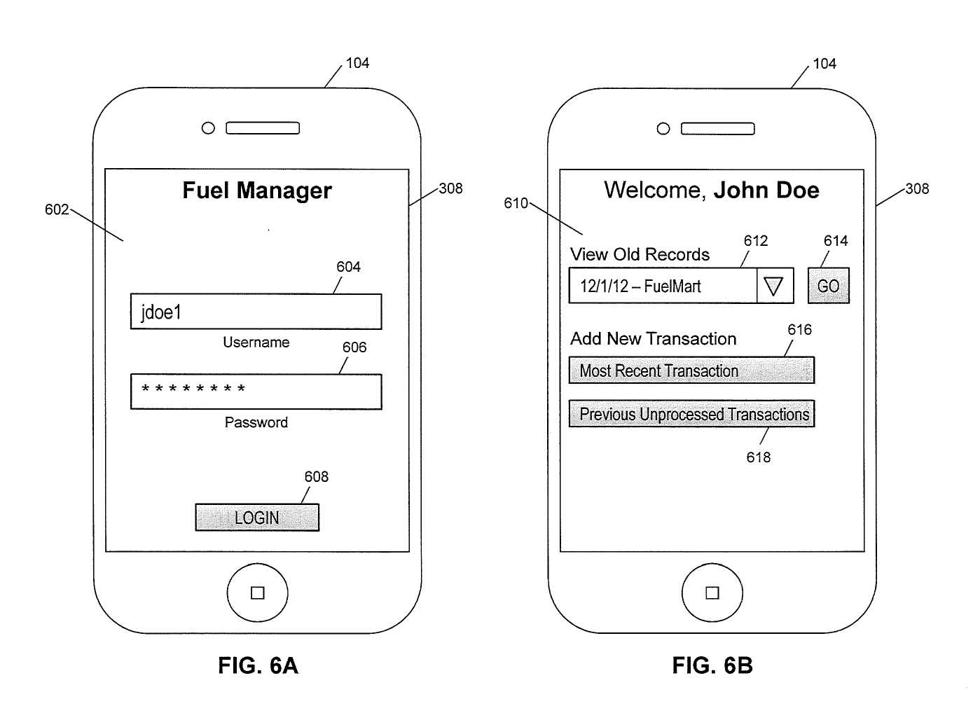

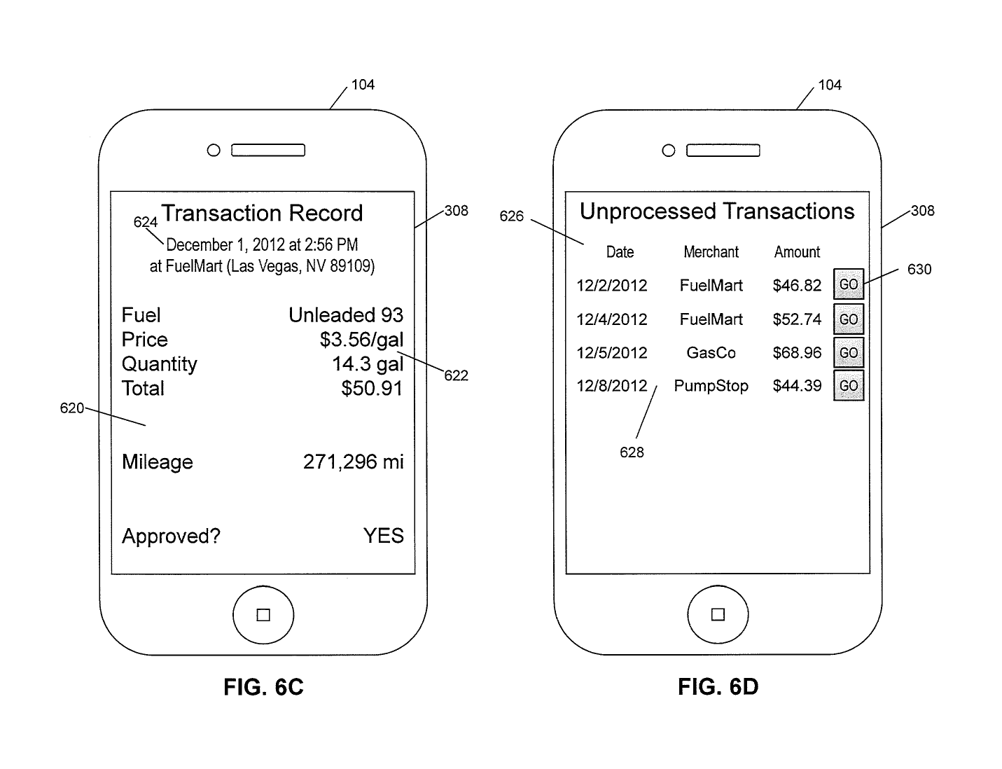

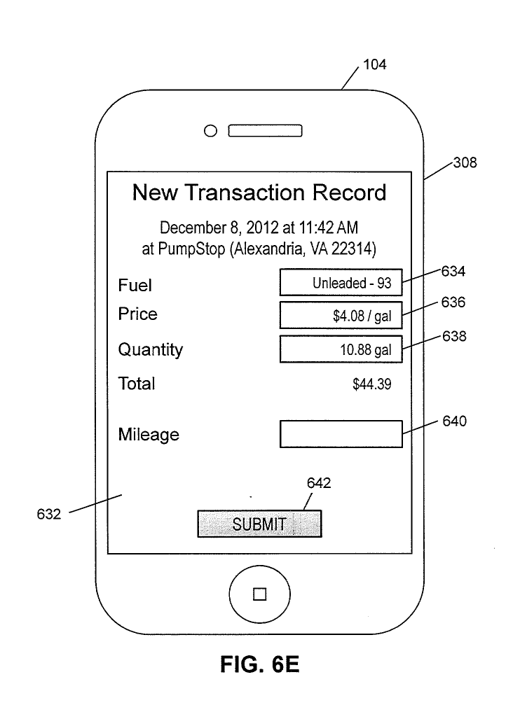

FIGS. 6A-6E illustrate an exemplary graphical user interface of the mobile device 104 for the input of additional transaction details for a financial transaction by the user 102 of the mobile device 104 for the use in the creation of a transaction record by the processing server 108.

In FIG. 6A, the display unit 308 of the mobile device 104 may display a login screen 602. The login screen 602 may include a username field 604 and a password field 606. The user 102 may input (e.g., via the input 310) a username and password into the respective username and password fields 604 and 606. The login screen 602 may further include a login button 608. When the user 102 interacts with the login button 608, the authentication information input into the fields 604 and 606 may be transmitted (e.g., by the transmitting unit 306) to the processing server 108 for identification of the user 102 (e.g., based on identification of a consumer data entry in the consumer database 110 related to the user 102).

After the user 102 has logged in, the display unit 308 may display a welcome screen 610 as illustrated in FIG. 6B. The welcome screen 610 may include a transaction record selection 612. The transaction record selection may be a drop-down menu or other type of selector (e.g., a table, list, etc.) for the selection of a previously created transaction record. The welcome screen 610 may also include a go button 614, which, when interacted with by the user 102, may present the user with the selected transaction record as discussed below. The welcome screen 610 may also include a most recent transaction button 616 and a previous unprocessed transactions button 618. The most recent transaction button 616 may be configured to present the most recent unprocessed (e.g., where the user 102 has not provided required additional transaction information) transaction to the user 102, as discussed below. The previous unprocessed transactions button 618 may present the user 102 with a list of unprocessed transactions for selection to provide required additional transaction information, as discussed below.

FIG. 6C illustrates a transaction record screen 620 displayed by the display unit 308, such as in response to user interaction with the go button 614 of the welcome screen 610. The transaction record screen 620 may display data for a previously created transaction record associated with the user 102. The transaction record screen 620 may include transaction data 622. The transaction data 622 may include information that may vary depending on the application as will be apparent to persons having skill in the relevant art. As illustrated in FIG. 6C, the transaction data 622 may include fuel type, fuel unit price, fuel quantity, transaction amount, vehicle mileage, and approval status. The transaction record screen 620 may further include identifying information 624, which may include a transaction time and/or date and a merchant involved in the financial transaction.

FIG. 6D illustrates a unprocessed transaction list screen 626 displayed by the display unit 310, such as in response to user interaction with the previous unprocessed transactions button 618 of the welcome screen 610 illustrated in FIG. 6B. The unprocessed transaction list screen 626 may include a list of unprocessed transactions 628 and a plurality of go buttons 630, where each go button 630 may correspond to a transaction in the list of unprocessed transactions list 628. The user 102 may interact with a go button 630 and may be presented with the new transaction screen 632 illustrated in FIG. 6E. The new transaction screen 632 may also be displayed by the display unit 308 upon user interaction with the most recent transaction button 616 of the welcome screen 610.

The new transaction screen 632 may include a plurality of fields that may correspond to transaction data for the financial transaction, such as fuel type field 634, fuel price field 636, and fuel quantity field 638. Each of the fields 634, 636, and 638 may be prepopulated based on the transaction data received from the processing server 108 by the receiving unit 304. In such an instance, the user 102 may not be required to provide the data for the corresponding fields, which may result in less time required of the user 102 to provide information for the creation of transaction records. The new transaction screen 632 may further include an additional transaction field, such as the mileage field 640 illustrated in FIG. 6E. The user 102 may input the mileage of the vehicle at the time of the transaction into the mileage field 640. The user 102 may then interact with a submit button 642, which may cause the transmitting unit 306 to transmit the additional transaction details and any modified transaction data (e.g., from the fields 634, 636, and 638) to the processing server 108 for use in the creation of the transaction record for the financial transaction.

It will be apparent to persons having skill in the relevant art that the new transaction screen 632 may display fields dependent on the type of transaction and/or the products or services purchased. For example, if the financial transaction is a non-fuel transaction, the new transaction screen 632 may include fields for input by the user 102 of a transaction category (e.g., vehicle services, refreshments, vehicle products, maintenance products, etc.), a description, etc. In some instances, the new transaction screen 632 may display multiple areas, such as for a financial transaction including both fuel and non-fuel purchase. For example, the new transaction screen 632 may display additional fields below the mileage field 640, such as for a transaction category and description.

In some embodiments, the mobile device 104 may be further configured to indicate to the user 102 when a new transaction requires additional information. In such an embodiment, the user 102 may receive, via the mobile device 104, a notification that new transaction data is received and that additional details are requested. The notification may be displayed by the display unit 308 and may include an application program notification, a short message service (SMS) message, a multimedia message service (MMS) message, an e-mail, or any other type of notification that will be apparent to persons having skill in the relevant art. The user 102 may then open the application program and enter in required additional details, such as illustrated in FIG. 6E.

Such an interface may enable the user 102 to provide additional transaction details as required by the company 106 quickly and efficiently. For example, the user 102 may stop at a merchant and purchase fuel for a vehicle owned by the company 106 using a fleet card issued to the company 106. Following the transaction, the user 102 may access the application program on the mobile device 104 and may request the transaction that had just taken place. The user 102 may then provide only the requested additional transaction details, which the processing server 108 may combine with the transaction data to create a transaction record to provide to the company 106. In such an embodiment, the user 102 may not be required to provide any transaction data, as the processing server 108 may receive the transaction data from another source apart from the user 102.

### Exemplary Method for Creating a Transaction Record

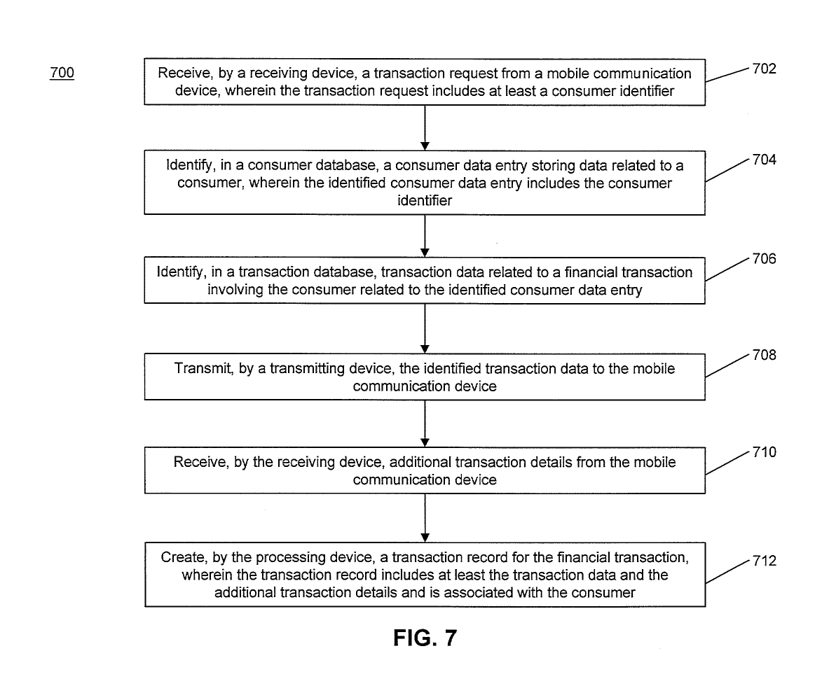

FIG. 7 illustrates a method 700 for the creating of a transaction record.

In step 702, a receiving device (e.g., the receiving unit 202) may receive a transaction request from a mobile communication device (e.g., the mobile device 104), wherein the transaction request includes at least a consumer identifier. In one embodiment, the transaction request may further include at least one of: a time and/or date, a location, and a payment card identification. In step 704, a consumer data entry storing data related to a consumer (e.g., the user 102) may be identified (e.g., by the processing unit 204) in a consumer database (e.g., the consumer database 110), wherein the identified consumer data entry includes the consumer identifier.

In step 706, transaction data related to a financial transaction involving the consumer 102 related to the consumer data entry may be identified in a transaction database (e.g., the transaction database 112). In one embodiment, the transaction request may further include a time and/or date, and identifying the transaction data may include identifying transaction data related to a financial transaction involving the consumer 102 conducted temporally proximal to the time and/or date included in the transaction request. In some embodiments, the transaction data may include at least one of: transaction amount, transaction time and/or date, merchant information, funding source, and geographic location. In one embodiment, the financial transaction may involve the purchase of fuel.

In step 708, a transmitting device (e.g., the transmitting unit 206) may transmit the identified transaction data to the mobile communication device 104. In step 710, the receiving device 202 may receive additional transaction details from the mobile communication device 104. In some embodiments, the additional transaction details may include at least one of: an approval code, a fuel quantity, a fuel unit price, a fuel type, a service type, an odometer reading, and an invoice number. In one embodiment, the transmitted transaction data may indicate the additional transaction details to be provided by a user (e.g., the user 102) of the mobile communication device 104.

In step 712, the processing device 204 may create a transaction record for the financial transaction, wherein the transaction record includes at least the transaction data and the additional transaction details and is associated with the consumer 102. In some embodiments, the method 700 may further include transmitting, by the transmitting device 206, the created transaction record for the financial transaction to a third party (e.g., the company 106).

### Exemplary Method for Submitting Transaction Details

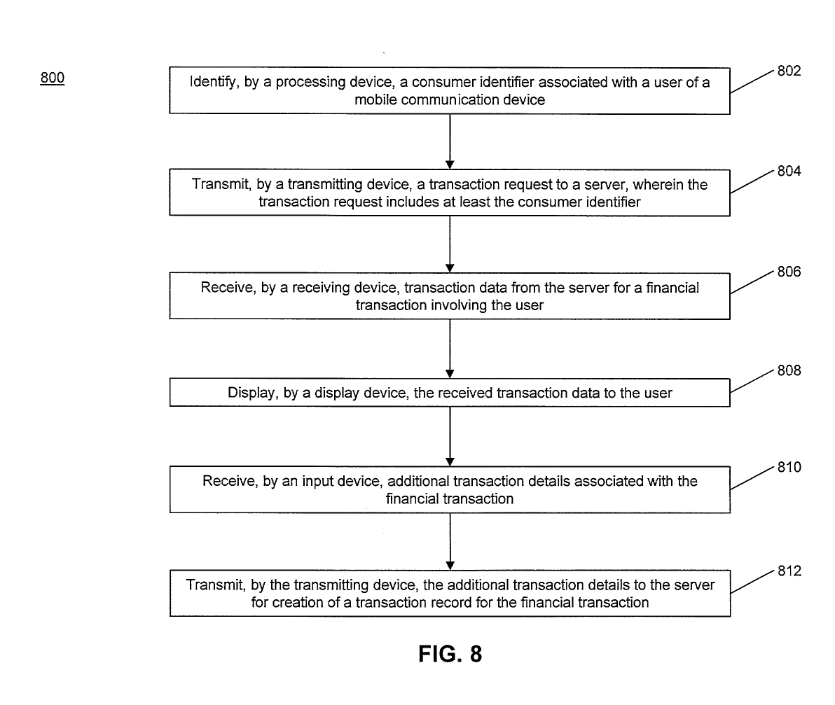

FIG. 8 illustrates a method 800 for submitting transaction details from a mobile communication device (e.g., the mobile device 104) to a processing server (e.g., the processing server 108) for use in the creation of a transaction record.

In step 802, a processing device (e.g., the processing unit 302) may identify a consumer identifier associated with a user (e.g., the user 102) of the mobile communication device 104. In one embodiment, identifying a consumer identifier may further include, receiving authentication information, transmitting the authentication information to a server (e.g., the processing server 108), and receiving the consumer identifier associated with the user 102 from the server 108. In step 804, a transmitting device (e.g., the transmitting unit 306) may transmit a transaction request to a server (e.g., the processing server 108), wherein the transaction request includes at least the consumer identifier. In one embodiment, the transaction request may include at least one of: a time and/or date, a location, and a payment card identification.

In step 806, a receiving device (e.g., the receiving device 304) may receive transaction data from the server 108 for a financial transaction involving the user 102. In one embodiment, the processing device 302 may identify a current time and/or date, the transaction request may further include the identified time and/or date, and the financial transaction involving the user 102 may have been conducted temporally proximal to the identified time and/or date. In some embodiments, the transaction data may include at least one of: transaction amount, transaction time and/or date, merchant information, funding source, and geographic location. In one embodiment, the financial transaction may involve the purchase of fuel.

In step 808, a display device (e.g., the display unit 308) may display the received transaction data to the user 102. In step 810, an input device (e.g., the input unit 310) may receive additional transaction details associated with the financial transaction. In one embodiment, the additional transaction details may include at least one of: an approval code, a fuel quantity, a fuel unit price, a fuel type, a service type, an odometer reading, and an invoice number. In some embodiments, the transaction data may indicate required transaction details, and displaying the received transaction data to the user 102 may include displaying a prompt to the user 102 to provide the required transaction details as the additional transaction details. In step 812, the transmitting device 306 may transmit the additional transaction details to the server 108 for creation of a transaction record for the financial transaction.

### Computer System Architecture

FIG. 9 illustrates a computer system 900 in which embodiments of the present disclosure, or portions thereof, may be implemented as computer-readable code. For example, the mobile device 104, the processing server 108, and the company 106 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4, 5, 7, and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communication infrastructure 906, such as a bus, message queue, network (e.g., the network 114), multi-core message-passing scheme, etc. The computer system 900 may also include a main memory 908 (e.g., random access memory, read-only memory, etc.), and may also include a secondary memory 99. The secondary memory 99 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive, the removable storage unit 918 may be a floppy disk. In one embodiment, the removable storage unit 918 may be non-transitory computer readable recording media.

In some embodiments, the secondary memory 99 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

Computer program medium and computer usable medium may refer to memories, such as the main memory 908 and secondary memory 99, which may be memory semiconductors (e.g. DRAMs, etc.). These computer program products may be means for providing software to the computer system 900. Computer programs (e.g., computer control logic) may be stored in the main memory 908 and/or the secondary memory 99. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 4, 5, 7, and 8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for the creation of transaction records and submission of transaction details. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for creating a transaction record, comprising:
receiving, by a receiving device, a transaction request from a mobile communication device, wherein the transaction request includes at least a consumer identifier;
identifying, in a consumer database, a consumer data entry storing data related to a consumer, wherein the identified consumer data entry includes at least the consumer identifier;
identifying, in a transaction database, transaction data related to a financial transaction involving the consumer related to the identified consumer data entry;
transmitting, by a transmitting device, the identified transaction data to the mobile communication device;
receiving, by the receiving device, additional transaction details from the mobile communication device; and
creating, by a processing device, a transaction record for the financial transaction, wherein the transaction record includes at least the transaction data and the additional transaction details from the mobile communication device and is associated with the consumer.

2. The method of claim 1, wherein
the transaction request further includes at least a time and/or date; and
identifying the transaction data includes identifying transaction data related to a financial transaction involving the consumer conducted temporally proximal to the time and/or date included in the transaction request.

3. The method of claim 1, wherein the transaction request further includes at least one of: a time and/or date, a location, and a payment card identification.

4. The method of claim 1, wherein the transaction data includes at least one of: transaction amount, transaction time and/or date, merchant information, funding source, and geographic location.

5. The method of claim 1, wherein the financial transaction involves the purchase of fuel.

6. The method of claim 1, wherein the additional transaction details include at least one of: an approval code, a fuel quantity, a fuel unit price, a fuel type, a service type, an odometer reading, and an invoice number.

7. The method of claim 1, wherein the transmitted transaction data indicates the additional transaction details to be provided by a user of the mobile communication device.

8. The method of claim 1, further comprising:
transmitting, by the transmitting device, the created transaction record for the financial transaction to a third party.

9. A method for submitting transaction details, comprising:
identifying, by a processing device, a consumer identifier associated with a user of a mobile communication device;
transmitting, by a transmitting device, a transaction request to a server 08, wherein the transaction request includes at least the consumer identifier;
receiving, by a receiving device, transaction data from the server for a financial transaction involving the user;
displaying, by a display device, the received transaction data to the user;
receiving, by an input device, additional transaction details associated with the financial transaction; and
transmitting, by the transmitting device, the additional transaction details to the server 108 for creation of a transaction record for the financial transaction.

10. The method of claim 9, wherein identifying a consumer identifier associated with a user of the mobile communication device comprises:
receiving, by the input device, authentication information;
transmitting, by the transmitting device, the authentication information to the server; and
receiving, by the receiving device, the consumer identifier associated with the user from the server.

11. The method of claim 9, further comprising:
identifying, by the processing device, a time and/or date, wherein
the transaction request further includes the identified time and/or date, and
the financial transaction involving the user was conducted temporally proximal to the identified time and/or date.

12. The method of claim 9, wherein the transaction request further includes at least one of: a time and/or date, a location, and a payment card identification.

13. The method of claim 9, wherein the transaction data includes at least one of: transaction amount, transaction time and/or date, merchant information, funding source, and geographic location.

14. The method of claim 9, wherein the financial transaction involves the purchase of fuel.

15. The method of claim 9, wherein
the transaction data indicates required transaction details, and
displaying the received transaction data includes displaying a prompt to the user 102 to provide the required transaction details as the additional transaction details.

16. The method of claim 9, wherein the additional transaction details include at least one of: an approval code, a fuel quantity, a fuel unit price, a fuel type, a service type, an odometer reading, and an invoice number.

17. A system for creating a transaction record, comprising:
a receiving device configured to receive a transaction request from a mobile communication device, wherein the transaction request includes at least a consumer identifier;
a processing device configured to
identify, in a consumer database, a consumer data entry storing data related to a consumer, wherein the identified consumer data entry includes the consumer identifier, and
identify, in a transaction database, transaction data related to a financial transaction involving the consumer related to the identified consumer data entry; and
a transmitting device configured to transmit the identified transaction data to the mobile communication device, wherein
the receiving device is further configured to receive additional transaction details from the mobile communication device, and
the processing device is further configured to create a transaction record for the financial transaction, wherein the transaction record includes at least the transaction data and the additional transaction details and is associated with the consumer.

18. The system of claim 17, wherein
the transaction request further includes at least a time and/or date, and
identifying the transaction data includes identifying transaction data related to a financial transaction involving the consumer conducted temporally proximal to the time and/or date included in the transaction request.

19. The system of claim 17, wherein the transaction request further includes at least one of: a time and/or date, a location, and a payment card identification.

20. The system of claim 17, wherein the transaction data includes at least one of: transaction amount, transaction time and/or date, merchant information, funding source, and geographic location.

21. The system of claim 17, wherein the financial transaction involves the purchase of fuel.

22. The system of claim 17, wherein the additional transaction details include at least one of: an approval code, a fuel quantity, a fuel unit price, a fuel type, a service type, an odometer reading, and an invoice number.

23. The system of claim 17, wherein the transmitted transaction data indicates the additional transaction details to be provided by a user of the mobile communication device.

24. The system of claim 17, wherein the transmitting device is further configured to transmit the created transaction record for the financial transaction to a third party.

25. A mobile communication device for submitting transaction details for a transaction record, comprising:
a processing device configured to identify a consumer identifier associated with a user of the mobile communication device;
a transmitting device configured to transmit, to a server, a transaction request, wherein the transaction request includes at least the consumer identifier;
a receiving device configured to receive, from the server, transaction data for a financial transaction involving the user;
a display device configured to display the received transaction data to the user; and
an input device configured to receive additional transaction details associated with the financial transaction, wherein
the transmitting device is further configured to transmit, to the server, the additional transaction details for creation of a transaction record for the financial transaction.

26. The mobile communication device of claim 25, wherein identifying a consumer identifier associated with a user comprises:
receiving, by the input device, authentication information;
transmitting, by the transmitting device, the authentication information to the server; and
receiving, by the receiving device, the consumer identifier associated with the user from the server.

27. The mobile communication device of claim 25, wherein
the processing device is further configured to identify a time and/or date,
the transaction request further includes the identified time and/or date, and
the financial transaction involving the user was conducted temporally proximal to the identified time and/or date.

28. The mobile communication device of claim 25, wherein the transaction request further includes at least one of: a time and/or date, a location, and a payment card identification.

29. The mobile communication device of claim 25, wherein the transaction data includes at least one of: transaction amount, transaction time and/or date, merchant information, funding source, and geographic location.

30. The mobile communication device of claim 25, wherein the financial transaction involves the purchase of fuel.

31. The mobile communication device of claim 25, wherein
the transaction data indicates required transaction details, and
displaying the received transaction data includes displaying a prompt to the user to provide the required transaction details as the additional transaction details.

32. The mobile communication device of claim 25, wherein the additional transaction details include at least one of: an approval code, a fuel quantity, a fuel unit price, a fuel type, a service type, an odometer reading, and an invoice number.
